(19) United States
(12) Patent Application Publication
(10) Pub. No.: US 2014/0150621 A1
(43) Pub. Date: Jun. 5, 2014

(54) CHAIN AND A CHAIN TOOL

(71) Applicants: Genady Rabinovich, Tiberias (IL); Ran Gur, Shimshit (IL)

(72) Inventors: Genady Rabinovich, Tiberias (IL); Ran Gur, Shimshit (IL)

(21) Appl. No.: 13/689,815

(22) Filed: Nov. 30, 2012

(51) Int. Cl. B23D 61/12; B28D 1/08

(52) U.S. Cl. CPC B23D 61/12; B28D 1/082
USPC 83/830; 83/698.11

(57) ABSTRACT

The present invention discloses a chain segment for a chain tool comprising a plurality of members consecutively connected therebetween. Each member has a median plane M disposed parallel between a first and a second flank of the member, bisecting the member thickness. Adjacent median planes M of adjacent members are disposed parallel with respect to each other and displaced therefrom by the member thickness.

### CROSS-REFERENCE TO RELATED APPLICATIONS

This patent application claims priority from co-pending Israeli Patent Application IL/223165 filed on Nov. 20, 2012.

### FIELD OF THE INVENTION

The present invention relates generally to chains, designed to move and/or remove material, as well as to a tool therefor.

### BACKGROUND OF THE INVENTION

Examples and limitations related hereto and brought herein below are intended to be illustrative and not exclusive. Other limitations of the related art will become apparent to those of skill in the art upon a reading of the specification and a study of the figures. An illustrative example of a chain used for cutting is a well-known chain-saw. However, such exemplary and illustrative purpose, and the related description and drawings herein, should be interpreted by way of illustrative purpose without limiting the scope of the present disclosure. Other types of chains and/or uses may well be considered as applicable for the utilization of the presently disclosed invention.

One exemplary use of chains is to remove material, as disclosed in, for example, U.S. Pat. No. 5,215,072, disclosing, inter alia, “. . . an abrasive particle impregnated mesh on an inclined surface and on select areas of its side skirts. The skirts cover as least a portion of the bores in the drive links and support links to retain and protect the fasteners therein.”

Thus, it may be advantageous to have a chain that may offer enhance performance and/or fewer parts. Numerous other advantages and features of the present invention may become readily apparent from the following detailed description of the invention and the embodiment thereof, from the claims, and from the accompanying drawings.

### SUMMARY OF THE INVENTION

In the following disclosure, aspects thereof are described and illustrated in conjunction with systems and methods which are meant to be exemplary and illustrative, not limiting in scope. The present disclosure may be further directed to a method of utilization and/or usage of such apparatuses

Accordingly, it is an object of the present invention to provide a novel, highly modular, chain tool having easy and simple-to-manufacture chains and/or tool bodies.

One aspect of the present invention generally concerns a chain segment for a tool comprising a plurality of members which are consecutively connected together. Each member has a median plane M which is disposed parallel to and which is interposed between a first and a second flank of the member, the median plane M bisecting the member thickness T_{M}. Adjacent median planes M of adjacent members are disposed parallel to the first median plane but displaced therefrom by the member thickness T_{M}.

Potentially, two subsequent members are pivotally connected together by means of a connector.

Potentially further, each one of the plurality of members comprises two connectors disposed between an outer side and an inner side of each member, with one connector disposed adjacent to a first sidewall of the member and the other connector disposed adjacent to a second sidewall of the member.

Moreover, the two connectors of a single member define therebetween a member length LM.

Optionally, members are identical.

Alternatively, the plurality of members comprises at least one keel member and at least one rider member.

Further alternatively, keel members and rider members alternate.

Potentially, the keel member has a keel depth D_{K} and the rider member has a rider depth D_{R}, wherein such depths are defined as the distances from the center of the connector C_{LC} to an inner side of the keel and the rider members, respectively.

Possibly, the keel depth D_{K} is greater than the rider depth D_{R}.

Optionally, the keel member length L_{MK} of the keel member is greater than the rider member length L_{MR} of the rider member.

Alternatively, the keel member length L_{MK} of the keel member is smaller than the rider member length L_{MR} of the rider member.

Potentially, the outer side of the at least one member is adapted to accommodate an appendage comprising a functional means for performing desired functions.

Another aspect of the present invention concerns a chain tool adapted to cooperate with chain segments. The chain tool comprises a tool body having a rotational symmetry about a longitudinal axis X and an envelope extending between a first lid and a second lid. The envelope comprises parallel circumferentially extending alternating ridge faces and groove faces. Each one of the ridge faces extends between a first fence and a second fence while each groove face extends between the second fence and a consecutive first fence. The chain tool further comprises at least one chain segment spiraling around the tool body in a direction away from the first lid and towards the second lid thereof.

Possibly, the tool body is solid.

Further possibly, the tool body is modular, comprising alternating and interfitting ridge rings and groove rings.

Potentially, members have their inner side touching the envelope.

Further potentially, each one of the rider members touches a corresponding ridge face while each keel member touches a groove face.

Moreover, a portion of each keel member is submerged below the ridge faces, and supported by the first and second fences, so that a ridge width W_{R} and a groove width W_{G} are generally similar to the member thickness T_{M}, while the groove depth G_{D} of the groove face, disposed radially inwardly below the ridge face, is generally the difference between the keel depth D_{K} and the rider depth D_{R}.

In addition to the exemplary aspects and embodiments described above, further aspects and embodiments will become apparent by reference to the accompanying figures and by study of the following detailed descriptions.

### BRIEF DESCRIPTION OF THE DRAWINGS

Exemplary and/or illustrative embodiments of the present invention will be presented herein below in the following figures, by way of example only. The present invention may be best understood from the following detailed description when read in connection with the accompanying drawings. In the drawings, like segments have the same reference numerals. When pluralities of similar segments are present, a single reference numeral may be assigned to each plurality of similar segments with a small letter designation referring to specific segments. When referring to the segments collectively or to a non-specific one or more of the segments, the small letter designation may be eliminated. It should be emphasized that according to common practice, various features of the drawings are not drawn to scale unless otherwise indicated. Dimensions of various features may be expanded and/or reduced and/or roughly shown and/or omitted entirely, to show details of particular components, for the purpose that the present disclosure may become more fully understood from the detailed description and the accompanying schematic figures.

Reference will now be made to the accompanying drawings, in which:

FIG. 1 is a schematic perspective representation of an exemplary first embodiment of a chain segment constructed according to the present invention;

FIG. 2 is a side elevational view of the first embodiment of the chain segment of FIG. 1;

FIG. 3 is a top plan view of the first embodiment of the chain segment of FIG. 1;

FIG. 4 is a schematic perspective representation of an exemplary second embodiment of a chain segment constructed according to the present invention;

FIG. 5 is a schematic perspective representation of an exemplary third embodiment of a chain segment constructed according to the present invention;

FIG. 6 is a schematic perspective representation of an exemplary fourth embodiment of a chain segment constructed according to the present invention;

FIG. 7 is a schematic perspective representation of a fifth embodiment of a chain segment constructed according to the present invention;

FIG. 8 is a schematic perspective representation of an exemplary embodiment of a chain tool accommodating a plurality of chain segments;

FIG. 9 is a schematic exploded representation of the exemplary embodiment of the chain tool of FIG. 8;

FIG. 10 is a schematic perspective representation of a modified embodiment of a chain tool accommodating a plurality of chain segments thereon;

FIG. 11 and FIG. 12 schematically illustrate optional convex and concave embodiments to the chain tool;

FIG. 13A to FIG. 13D are schematic representations of an exemplary sixth embodiment of a chain member of a chain segment, respectively showing an end view, a side elevational view, a top plan view, partially in section, and a perspective view;

FIG. 14 is a schematic representation of an exemplary sixth embodiment of a chain segment comprising a plurality of the chain members shown on FIGS. 13A to 13D; and

FIG. 15 is a schematic perspective representation of an exemplary embodiment of a chain tool having a plurality of the sixth embodiment chain segments wrapped therearound.

### DETAILED DESCRIPTION OF THE ILLUSTRATED EMBODIMENTS

As required, a schematic, exemplary embodiment of the present chain and chain tool are disclosed herein, however, it is to be understood that the disclosed embodiments are merely exemplary of the present disclosure, which may be embodied in various and/or alternative forms. Specific structural and functional details disclosed herein are not to be interpreted as limiting, but merely as a basis for the claims and as a representative basis for teaching one skilled in the art to variously employ the present disclosure in virtually any appropriately detailed structure.

Aspects, advantages and/or other features of exemplary embodiments of the invention will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific segment includes all technical equivalents that operate in a similar manner to accomplish a similar purpose.

Exemplary embodiments may be adapted for many different purposes and are not intended to be limited to the specific exemplary purposes set forth herein. Other non-limiting examples of such embodiments are compositions that may be used, for example, for structural components. Those skilled in the art would be able to adapt the embodiments of the present disclosure, depending for example, on the intended use of the embodiment.

In FIGS. 1 to 3, a first embodiment of a chain segment 110 is shown. The first embodiment chain segment 110 comprises a plurality of first embodiment members 120. Each one of the plurality of first embodiment members 120 comprises two generally parallel and opposing first and second flanks 170,180 separated by a first embodiment member thickness T_{M1}. The first and second flanks 170,180 are effectively connected together by a peripheral portion 122 having generally opposing inner and outer sides 124, 126. The inner and outer sides, or top and bottom, 124,126 which are effectively connected together by first and second sidewalls 132,134 respectively.

Any two subsequent first embodiment members 120 are pivotally connected together by means of a connector 140. In the first embodiment chain segment 110, the connector 140 comprises a pin 142 passing through two adjacent and co-aligned through-holes or bores 150. In each one of the plurality of first embodiment members 120, there are two connectors 140 at opposite first and second ends 136,138 adjacent to the first and a second sidewalls 132, 134. Accordingly, in each one of the plurality of first embodiment members 120, there are two through-holes or bores 150. Each through-hole or bore 150 passes through the member thickness T_{MJ}, connecting the first and second flanks 170,180 and opening therethrough.

The two connectors 140 of a single member 120 define therebetween a member length L_{M}. In the first embodiment chain segment 110, the pin 142 is inserted through two serially aligned members 120 and passes through two matching and co-aligned pin through-holes or bores 150, each in one of the two neighboring members 120. At least some of the plurality of members 120 may be provided with an appendage 160 on and/or about the outer or upper side 126 that may accommodate functional means for performing desired functions.

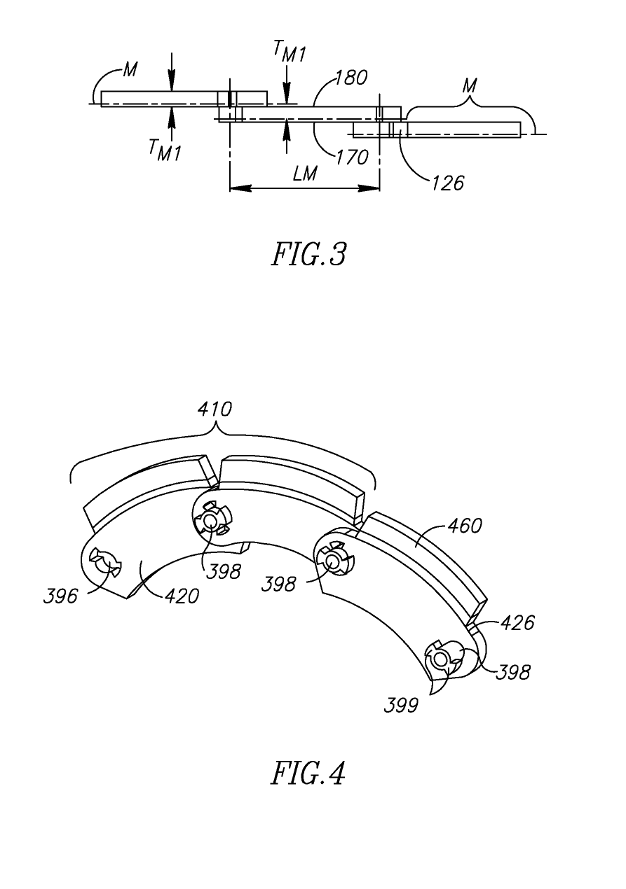

As can be best seen in FIG. 3, each one of the plurality of first embodiment members 120 comprises a median plane M which is interposed between the generally parallel and opposite first and second flanks 170,180 so as to bisect the member thickness T_{M1}. As members 120 are chained together so as to form a chain segment 110, the second flank 180 of a preceding member 120 will abut and partially overlap the first flank 170 of a subsequent member 120, so that median planes M of subsequent members 120 are disposed parallel relative to each other. However, members 120 may be chained together so as to form a chain segment 110 wherein the second flank 180 of a succeeding member 120 may abut and partially overlapping the first flank 170 of a preceding member 120. In the first embodiment of the chain segment 110, adjacent median planes M are disposed parallel with respect to each other and are displaced from each other by the member thickness T_{M}.

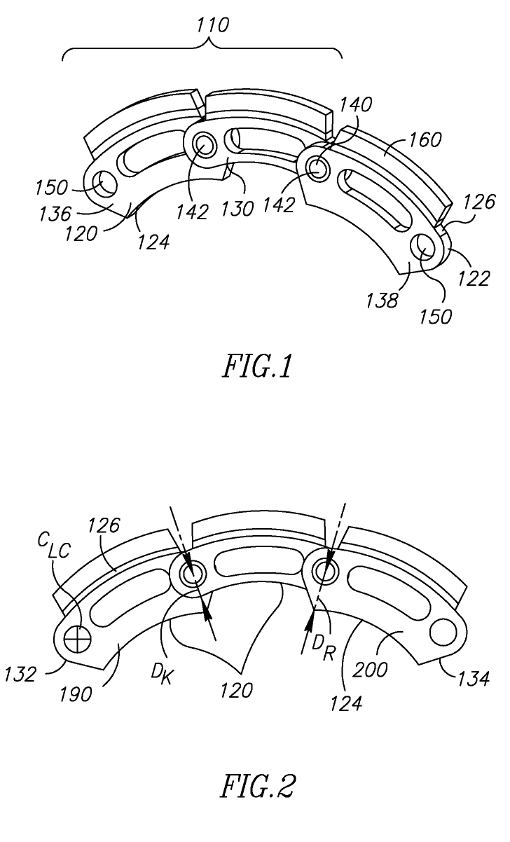

Attention is presently directed to FIG. 2. In the first embodiment of the chain segment 110, there is at least one keel member 190 and at least one rider member 200. The keel member 190 has a keel Depth D_{K} and the rider member has a rider depth D_{R}. The keel depth D_{K} and the rider depth D_{R} are defined as the distance from the center of the connector C_{LC} to the inner or bottom sides 124 of the keel and the rider members 190,200, respectively, disposed generally below the connector 140 as viewed in FIG. 2. In the first embodiment of the chain segment 110, the keel depth D_{K} is greater than the rider depth D_{R}.

Attention is presently drawn to FIG. 4, showing a schematic illustration of a second chain segment 410. Since the second embodiment of the chain segment 410 is generally similar to the first embodiment of the chain segment 110, components which are similar between the second embodiment chain segment 410 and the first embodiment chain segment 110 will be annotated by similar numbers increased by 300.

The second embodiment chain segment 410 comprises a plurality of second embodiment members 420. Any two serial or adjacent second embodiment members 420 are pivotally connected together by means of a lug 398. At least some of the plurality of second embodiment members 420 may be provided with an appendage 460 on or about an outer side 426 thereof that may accommodate functional means for performing desired functions, as is well known in the art. In the second embodiment chain segment 410, the lug 398 is integral with one of the second embodiment member 420 and is insertable through a corresponding mount or keyhole 396 of a preceding and/or subsequent second embodiment members 420. The lug 398 has at least one radial projection 399 extending away from the lug 398 and the mount or keyhole 396 is shaped as to allow the at least one radial projection 399 to pass therethrough when the lug 398 is in a certain position while preventing such passage therethrough in any other position, so that the mount 396 facilitates the insertion of the lug 398 when the members 420 are within an insertion range of positions relative to one another, and prevents insertion and/or extraction when the members 420 are in a securing range of positions relative to each other, as is known in the art.

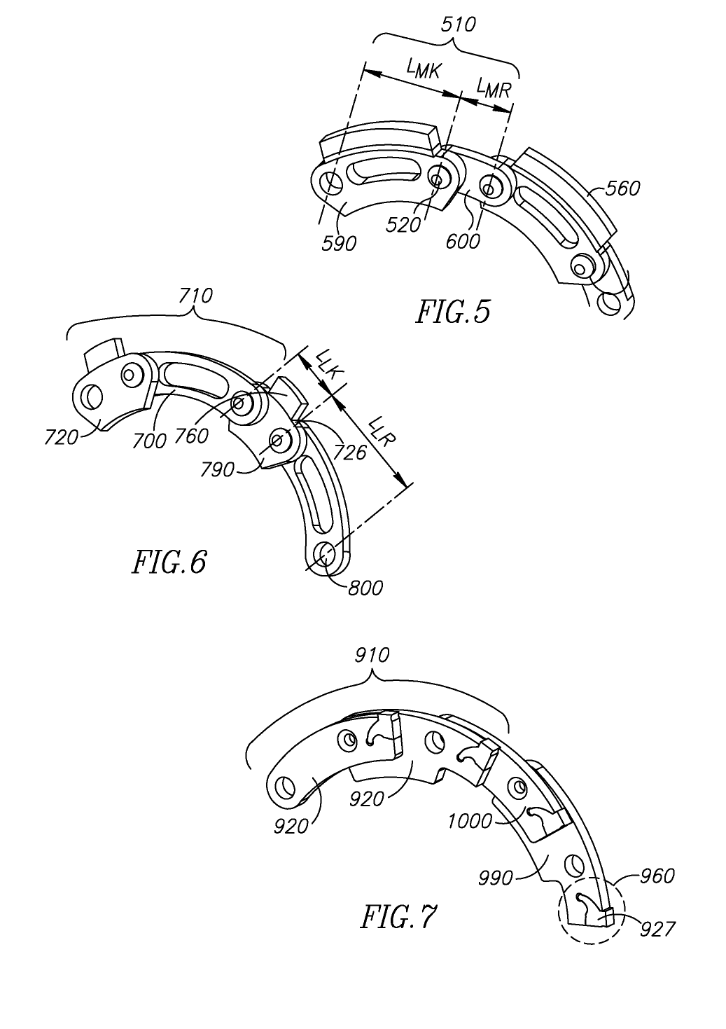

Attention is presently drawn to FIG. 5, showing a schematic illustration of a third embodiment of a chain segment 510. Since the third embodiment of the chain segment 510 is generally similar to the first embodiment of the chain segment 110, components which are similar between the third embodiment chain segment 510 and the first embodiment chain segment 110 will be annotated by similar numbers increased by 400. The third embodiment chain segment 510 comprises a plurality of third embodiment members 520. In the third embodiment of the chain segment 510, there is at least one keel member 590 and at least one rider member 600. In the third chain segment embodiment 510, a keel member length L_{MK} of the keel member 590 is greater than the rider member length L_{MR} of the rider member 600. Moreover, in the third embodiment of the chain segment 510, only keel members 590 are shown to be provided with an appendage 560 on or about an outer side 526 thereof that may accommodate functional means for performing desired functions. However, rider members 600 may alternatively and/or additionally be provided with appropriate appendages (not shown).

Attention is presently drawn to FIG. 6, showing a schematic illustration of a fourth embodiment of a chain segment 710. Since the fourth embodiment of the chain segment 710 is generally similar to the first embodiment of the chain segment 110, components which are similar between the fourth embodiment chain segment 710 and the first embodiment chain segment 110 will be annotated by similar numbers increased by 600. The fourth embodiment chain segment 710 comprises a plurality of fourth embodiment members 720. In the fourth embodiment of the chain segment 710, there is at least one keel member 790 and at least one rider member 800. In the fourth chain segment embodiment 710, the keel member length L_{LK} of the keel member 790 is smaller than the rider member length L_{LR} of the rider member 700. Moreover, in the fourth embodiment of the chain segment 710, only keel members 790 are shown to be provided with an appendage 760 on or about an outer side 726 thereof that may accommodate functional means for performing desired functions. However, rider members 700 may alternatively and/or additionally be provided with appropriate appendages (not shown).

Attention is presently drawn to FIG. 7, showing a schematic illustration of a fifth embodiment of a chain segment 910. Since the fifth embodiment of the chain segment 910 is generally similar to the first embodiment of the chain segment 110, components which are similar between the fifth embodiment chain segment 910 and the first embodiment chain segment 110 will be annotated by similar numbers increased by 800. The fifth embodiment chain segment 910 comprises a plurality of fifth embodiment members 920. In the fifth embodiment of the chain segment 910, there is at least one keel member 990 and at least one rider member 1000. In the fifth embodiment of the chain segment 910, the keel members 990 as well as the rider members 1000 are shown to be provided with an appendage 960 on or about an outer side (not shown) and/or a first and/or a second sidewall thereof that may accommodate functional means for performing desired functions, such as a cutting insert 927. However, keel members 990 and/or rider members 1000 may alternatively be provided with appropriate appendages (not shown). In the fifth embodiment of the chain segment 910, the appendage 960 may accommodate a cutting insert and a pocket therefor, as is well known in the art.

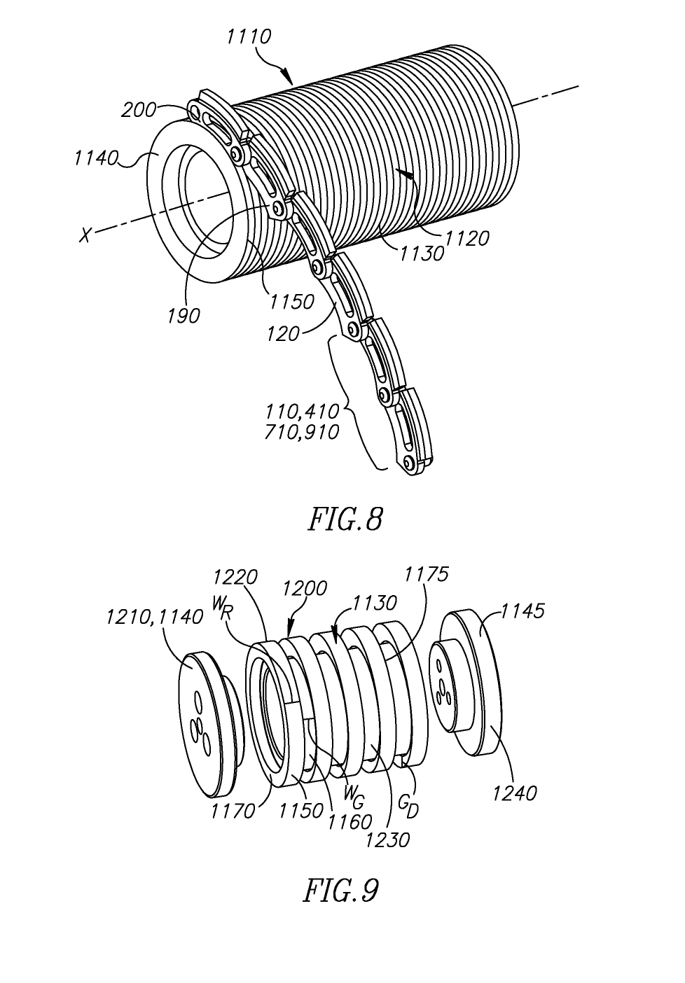

Chain segments, such as first, second, third, fourth and/or fifth exemplary embodiments of chain segments 110,410,510,710, and 910, but not limited thereto, are generally designed to be used in association with a chain tool. An exemplary embodiment of such a chain tool 1110 is shown in FIGS. 8 and 9. The exemplary embodiment chain tool 1110 comprises a tool body 1120 about which at least one exemplary first embodiment of the chain segment 110 is located. However, any other conceivable member and/or segment may be employed, without limiting the scope of the invention as claimed. The tool body 1120 has a rotational symmetry about a longitudinal axis X and comprises an envelope 1130 extending generally axially away from a first lid 1140 so as to terminate at a second lid 1145 as seen in FIG. 9. The envelope 1130 describes a surface of revolution and any desirable curve may be used as its outline. The envelope 1130 of the tool body 1120 comprises parallel and alternating ridge faces 1150 and groove faces 1160 extending circumferentially around the envelope 1130. Each one of the ridge faces 1150 extends between a first fence 1170 and a second fence (hidden on FIGS. 8 and 9), while a consecutive groove face 1160 extends between the second fence and a consecutive first fence 1170.

The tool body 1120 may be solid and/or hollow, as desired. Moreover the tool body 1120 may be monolithic and/or modular, as desired. The tool body 1120 of the exemplary embodiment of the chain tool 1110 shown in FIG. 9 schematically illustrates a modular tool body 1200. The modular tool body 1200 comprises a bottom lid 1210 having the first lid 1140 as its outer face, alternating pluralities of ridge rings 1220 and groove rings 1230 interfitting and extending axially from the bottom lid 1210 so as to terminate at a top lid 1240.

Returning now to FIG. 8, a plurality of first embodiment chain segments 110 may be wrapped around the envelope 1130. Members 120 of the chain segment 110 may have their inner side 124 (shown in FIGS. 1 to 3, and hidden in FIG. 8) touching the envelope 1130. Each one of the rider members 200 rides a ridge face 1150 of the tool body 1120, while each one of the keel members 190 is supported by one of the groove faces 1160. A portion of each keel member 190 is submerged below the ridge faces 1150 and supported by the first and second fences of the envelope 1130. A ridge width W_{R} and a groove width W_{G} are generally similar to the member thickness T_{M}, while a groove depth G_{D} of each groove face 1160, which extends radially inwardly below the ridge face 1150, is generally the difference between the keel depth D_{K} and the rider depth D_{R}.

FIG. 10 schematically illustrates a schematic modified embodiment of a chain tool 1410. Since the modified embodiment of the chain tool 1410 is generally similar to the exemplary embodiment of the chain tool 1110, components which are similar between the modified embodiment chain tool 1410 and the exemplary embodiment chain tool 1110 will be annotated by similar numbers increased by 300. The chain tool 1410 has a tool body 1420 having a generally frusto-conical shape, with a bottom lid 1510 (seen on the bottom left of FIG. 10) having a smaller bottom lid diameter R_{BL} than a top lid diameter R_{TL} of a top lid 1520 of the tool body 1420. Two parallel chain lengths 1610 are wrapped about the tool body, starting adjacent the bottom lid 1510 and spiraling away around the tool body 1420 so as to terminate adjacent to the top lid 1520. Each chain length 1610 comprises a plurality of chain segments consecutively attached to form the chain length 1610.

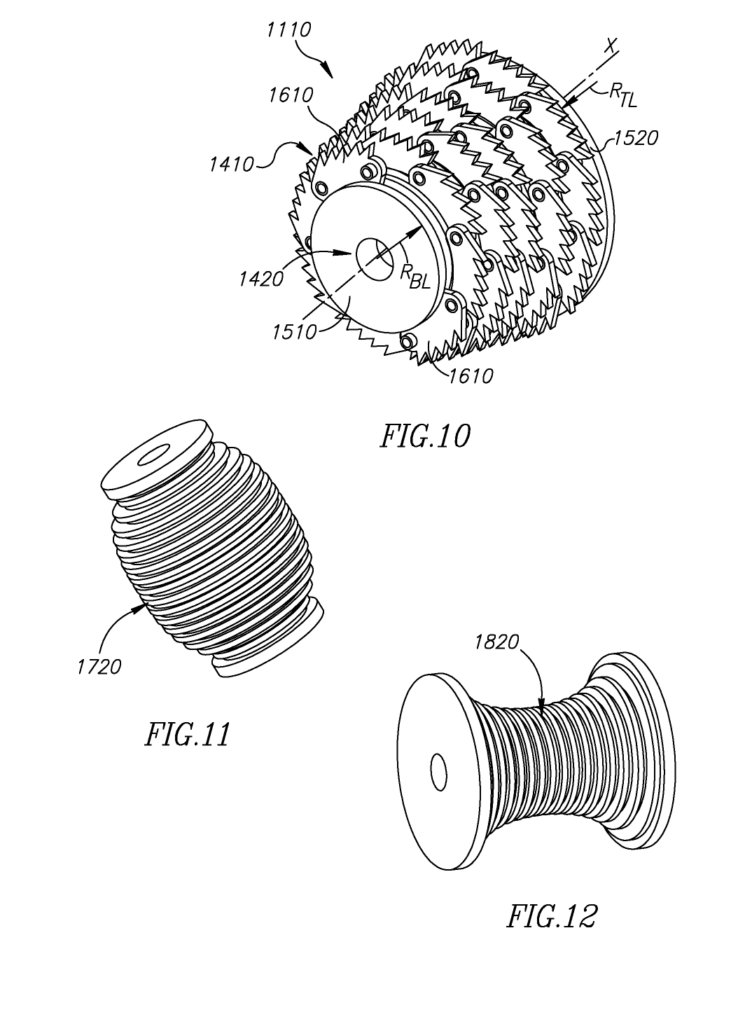

Attention is presently directed to FIG. 11 and FIG. 12. Illustrative convex and concave embodiments of tool bodies 1720,1820, respectively, are schematically rendered. These embodiments are shown as an example only, to demonstrate that many other, not always easily defined shapes and/or forms, are feasible for application as a tool body.

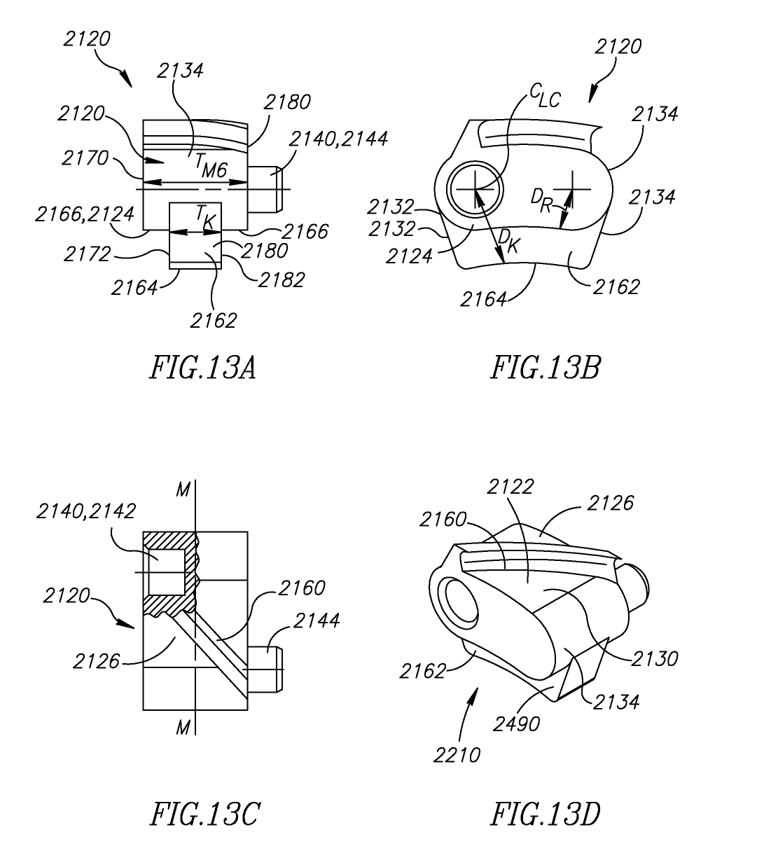

FIGS. 13, 14 and 15 show a schematic general representation of an exemplary sixth embodiment of a chain member 2120, a sixth embodiment of a chain segment 2110, and a particular embodiment of a chain tool 2310, respectively. Since the sixth embodiment of the chain segment 2110 as well as the sixth embodiment chain member 2120 are generally similar to the first embodiment of the chain segment 110, components which are similar between the sixth embodiment chain segment 2110 and the first embodiment chain segment 110 will be annotated by similar numbers increased by 2000. Similarly, since the particular embodiment of the chain tool 2310 is generally similar to the exemplary embodiment of the chain tool 1110, components which are similar between the modified embodiment chain tool 2310 and the exemplary embodiment chain tool 1110 will be annotated by similar numbers increased by 1200.

The sixth embodiment chain segment 2110 comprises a plurality of sixth embodiment chain members 2120. Each one of the plurality of sixth embodiment chain members 2120 comprises two generally parallel and opposing first and second flanks 2170,2180 separated by a member thickness T_{M6}. The first and second flanks 2170, 2180 are connected therebetween by a periphery 122 having generally opposing inner and outer sides 2124, 2126. The inner and outer sides 2124, 2126 are connected therebetween by a first and a second sidewall 2132, 2134 respectively.

Any two subsequent sixth embodiment members 2120 are pivotally connected together by means of a connector 2140. In the sixth embodiment chain segment 2110, the connector 2140 is in a shape of a pin and a socket. On the first flank 2170 adjacent to the second sidewall 2134 and generally between the inner and outer sides 2124, 2126, there is disposed a socket 2142 while from the opposite second flank 2180, adjacent to the first sidewall 2132 and generally between the inner and outer sides 2124,2126, there is disposed a pin 2144. The pin 2144 protrudes away from the second flank 2180 generally transversely thereto, while the socket 2142 is sunk into the member 2120 inside of the first flank 2170 and generally transversely thereto.

The outer side 2126 is provided with a sixth embodiment appendage 2160 upstanding therefrom. The sixth embodiment appendage 2160 is adapted to chip removing machinery. The inner side 2124 has a keel 2162 disposed thereon, merging with the inner side 2134 and jutting outwardly away therefrom so as to terminate at a keel face 2164. The keel 2162 has generally parallel and opposed first and second keel flanks 2172,2182 merging with, and upstanding from, the inner side 2124 and interconnected by the keel face 2164 and generally opposed first and second keel walls 2132, 2134 extending therebetween generally transversely to the first and second keel flanks 2172,2182. The keel 2162 is disposed generally about the center of the sixth embodiment member wherein the width T_{M6} is defined as the distance between the first and second flanks 2170,2180, and has a keel thickness T_{K} defined as the distance between the first and the second keel flanks 2172,2182. The keel 2162 is flanked by generally similar rider faces 2166 of the inner side 2124. As best seen in FIG. 13C, each one of the plurality of members 2120 comprises a median plane M passing between the generally parallel and opposing first and second flanks 2170,2180 and bisecting the sixth embodiment member thickness T_{M6}.

In the sixth embodiment of the chain segment 2110, each sixth embodiment member 2120 has a rider depth D_{R} defined as a distance from the center of the connector C_{LC} to the inner or lower side 2124 of the sixth embodiment member 2120 and a keel depth D_{K} defined as the distance from the center of the connector C_{LC} to the keel face 2164. In the sixth embodiment of the chain segment 2110, the keel depth D_{K} is greater than the rider depth D_{R}.

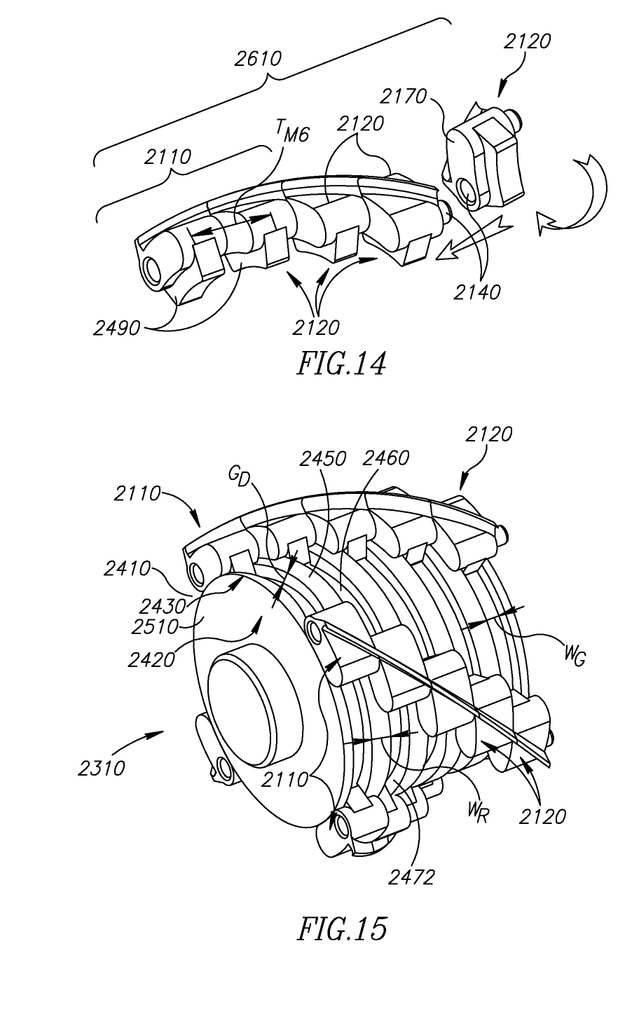

Attention is presently directed to FIG. 14. Sixth embodiment chain members 2120 are arrayed as a sixth embodiment chain segment 2110 by moving the first flank 2170 of a subsequent chain member 2120 towards the second flank 2180 (hidden in FIG. 14) of a preceding chain member 2120. The connector 2140 then connects the preceding and the subsequent chain members 2120 together, as is well known in the art. As the sixth embodiment members 2120 are chained together so as to form the sixth embodiment chain segment 2110, median planes M of subsequent sixth embodiment members 2120 are disposed parallel relative to each other. In the sixth embodiment of the chain segment 2110, adjacent median planes M are disposed parallel to each other displaced by a distance corresponding to the member thickness T_{M6}.

Referring now to FIG. 15, there is shown a particular embodiment of a chain tool 2410 having sixth embodiment chain segments 2110 wrapped therearound. Since the particular embodiment of the chain tool 2410 is generally similar to the exemplary embodiment of the chain tool 1110, components which are similar between the particular embodiment chain tool 2410 and the exemplary embodiment chain tool 1110 will be annotated by similar numbers increased by 1000. The chain tool 2410 has a tool body 2420 having a generally cylindrical shape, with a bottom lid 2510 (seen on the bottom left of FIG. 15) and an opposing top lid (not shown) of the tool body 2420. Four generally parallel chain segments 2110 are wrapped around the tool body 2420, starting adjacent the bottom lid 2510 and spiraling away around the tool body 2420 so as to terminate adjacent the top lid (not shown). Each chain length 2610 comprises a plurality of chain segments 2110 consecutively attached so as to form the chain length 2610.

The tool body 2420 comprises an envelope 2430 extending generally axially away from the first lid 2440 so as to terminate at the second lid (hidden in FIG. 15). The envelope 2430 describes a surface of revolution and any desirable curve may be used as its outline. The envelope 2430 of the tool body 2420 comprises parallel and alternating ridge faces 2450 and groove faces 2460 extending circumferentially around the envelope 2430. Each one of the groove faces 2450 extends between a first fence (hidden in FIG. 15) and a generally parallel and opposing second fence 2472, while a consecutive groove face 2460 extends between the second fence 2472 and a consecutive first fence (not shown).

Each one of the plurality of sixth embodiment members 2120 has its inner side 2124 touching the envelope 2430. The inner side 2124 of each member 2120 rides one of the ridge faces 2450 of the tool body 2420, with each one of the rider faces 2166 of each one of the inner sides 2124 touching consecutive ridge faces 2450, while each keel face 2164 is facing, but not necessarily abutting, the groove face 2460. A portion of each keel member 2490 is submerged below one of the ridge faces 2450 and is supported by the first and second fences of the envelope 2430. A ridge width W_{R} and a groove width W_{G} are generally similar to the member thickness T_{M}, while the groove depth G_{D} of each groove face 1160, extending radially inwardly below the ridge face 1150, is generally the difference between the keel depth D_{K} and the rider depth D_{R}.

In view of the foregoing, it shall be evident that the present invention provides a unique system for constructing a modular, configurable, chain tool that facilitates wrapping a chain thereabout, as well as chain segments facilitating such modularity.

All directional references (for example, upper, lower, upward, downward, left, right, leftward, rightward, top, bottom, above, below, vertical, horizontal, clockwise, and counterclockwise) are only used for identification purposes to aid the reader's understanding of the present disclosure, and may not create limitations, particularly as to the position, orientation, or use of the devices and/or methods disclosed herein. Joinder references (for example, attached, coupled, connected, hinged, and the like) are to be construed broadly and may include intermediate members between a connection of segments and relative movement between segments. As such, joinder references do not necessarily infer that two segments are directly connected and in fixed relation to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, not create any limitations, particularly as to the description, operation, or use unless specifically set forth in the claims.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While certain exemplary embodiments have been described and shown in the accompanying drawings, it is to be understood that such embodiments are merely illustrative of and not restrictive on the broad present disclosure, and that this present disclosure not be limited to the specific constructions and arrangements shown and described, since various other modifications and/or adaptations may occur to those of ordinary skill in the art. It is to be understood that individual features shown or described for one embodiment may be combined with individual features shown or described for another embodiment. It is to be understood some features are shown or described to illustrate the use of the present disclosure in the context of functional segments and such features may be omitted within the scope of the present disclosure and without departing from the spirit of the present disclosure as defined in the appended claims.

1. A chain segment for a tool comprising a plurality of members consecutively connected therebetween, each member has a median plane M passing parallelly between a first and a second flanks of the member, bisecting a member thickness T_{M}, wherein adjacent median planes M of adjacent members are parallelly displaced by the member thickness T_{M}.

2. The chain segment of claim 1, wherein two subsequent members are swivelly connected therebetween by a connector.

3. The chain segment of claim 2, wherein each of the plurality of members comprises two connectors disposed between an outer side and an inner side of each member, with a connector adjacent a first sidewall and another connector adjacent a second sidewall of the member.

4. The chain segment of claim 3, wherein the two connectors of a single member define therebetween a member length L_{M}.

5. The chain segment of claim 4, wherein members are identical.

6. The chain segment of claim 4, wherein the plurality of members comprises at least one keel member and at least one rider member, and wherein keel members and rider members alternate.

7. The chain segment of claim 6, wherein the keel member has a keel Depth D_{K} and the rider member has a rider depth D_{R} defined as a distance from a center of the connector C_{LC} to an inner side of the keel and the rider members, respectively, disposed away from the center of the connector C_{LC} in a direction away from the outer side, and wherein the keel depth D_{K} is greater than the rider depth D_{R}.

8. The chain segment of claim 6, wherein a keel member length L_{MK} defined as the member length L_{M} of the keel member is greater than a rider member length L_{MR} defined as the member length L_{M} of the rider member.

9. The chain segment of claim 6, wherein a keel member length L_{MK} defined as the member length L_{M} of the keel member is smaller than a rider member length L_{MR} defined as the member length L_{M} of the rider member.

10. The chain segment of claim 3, wherein the outer side of the at least one member is adapted to accommodate an appendage comprising functional means for performing desired functions.

11. A chain tool adapted to cooperate with chain segments, comprising: a tool body having a rotational symmetry about a longitudinal axis X and an envelope extending between a first lid and a second lid, the envelope comprising parallel circumferentially extending alternating ridge faces and groove faces, each of the ridge faces extending between a first fence and a second fence while each groove face extends between the second fence and a consecutive first fence, the chain tool further comprising at least one chain segment spiraling about the tool body in a direction away from the first lid and towards the second lid thereof.

12. The chain tool of claim 11, wherein the tool body is solid.

13. The chain tool of claim 11, wherein the tool body is modular, comprising alternating and interfitting ridge rings and groove rings.

14. The chain tool of claim 11, wherein members have their inner side touching the envelope.

15. The chain tool of claim 14, wherein members comprises at least one keel member and at least one rider member, with keel members and rider members alternate and wherein each of the rider members touches a corresponding ridge face while each keel member touches a groove face.

16. The chain tool of claim 15, wherein a portion of each keel member is submerged below the ridge faces and supported by the first and second fences, and wherein a ridge width W_{R} and a groove width W_{G} are generally similar to a member thickness T_{M}, while a groove depth G_{D} of the groove face radially inwardly below the ridge face is generally a difference between a keel depth D_{K} defined as a distance from a center of a connector C_{LC} to an inner side of the keel and a rider depth D_{R} defined as a distance from a center of a connector C_{LC} to an inner side of member.
